(19) United States
(12) Patent Application Publication
(10) Pub. No.: US 2013/0044853 A1
(43) Pub. Date: Feb. 21, 2013

(54) FEED WATER AND STEAM HEADER AND NUCLEAR REACTOR HAVING THE SAME

(71) Applicants: Dong Ok KIM, Daejeon (KR); Shun CHOI, Daejeon (KR); Tae Wan KIM, Daejeon (KR); Gyu Mahn LEE, Daejeon (KR); In Su HAN, Daejeon (KR); Ki Jong JANG, Daejeon (KR); Hyun Jin PARK, Daejeon (KR)

(72) Inventors: Dong Ok KIM, Daejeon (KR); Shun CHOI, Daejeon (KR); Tae Wan KIM, Daejeon (KR); Gyu Mahn LEE, Daejeon (KR); In Su HAN, Daejeon (KR); Ki Jong JANG, Daejeon (KR); Hyun Jin PARK, Daejeon (KR)

(73) Assignee: KOREA ATOMIC ENERGY RESEARCH INSTITUTE, Daejeon (KR)

(21) Appl. No.: 13/567,425

(22) Filed: Aug. 6, 2012

(30) Foreign Application Priority Data
Aug. 19, 2011 (KR) 10-2011-0082883

(51) Int. Cl. G21C 15/12; F22B 37/22; F22B 29/06; F22B 1/02

(52) U.S. Cl. 376/384; 122/32; 122/235.15; 122/362; 122/367.1

(57) ABSTRACT

A feed water and steam header equipped to a feed water nozzle or a steam nozzle of a reactor vessel in a steam generator for an integrated nuclear reactor is provided. The feed water and steam header may include a nozzle connection portion connected to a steam nozzle or a feed water nozzle of a reactor vessel, a header flange protruded outward from a lower part of the nozzle connection portion, and a tube connection portion disposed on two pipelines branched from the nozzle connection portion and connected to a tube of the steam generator.

### CROSS-REFERENCE TO RELATED APPLICATION

This application claims the benefit of Korean Patent Application No. 10-2011-0082883, filed on Aug. 19, 2011, in the Korean Intellectual Property Office, the disclosure of which is incorporated herein by reference.

### BACKGROUND

1. Field of the Invention

The present invention relates to a feed water and steam header connected to a feed water nozzle and a steam nozzle of an integrated nuclear reactor in the form of a pressurized water reactor (PWR) in a nuclear plant, and a nuclear reactor having the same.

2. Description of the Related Art

Nuclear power generation uses a great deal of energy of nuclear materials such as uranium (Ur). To convert nuclear energy generated by atomic fission and atomic fusion into electric energy by slowly diffusing the nuclear energy, various types of nuclear reactors such as a pressurized water reactor (PWR), a pressurized heavy water reactor (PHWR), a boiling water reactor (BWR), and a liquid metal reactor (LMR) are used.

The PWR system may include a nuclear reactor, a steam generator, a reactor cooling pump (RCP), a pressurizer, and the like. A coolant circulation circuit is constituted by cold leg piping and hot leg piping.

The steam generator of the nuclear plant may generate steam during a reactor power operation by heating secondary cooling water using heat of a reactor coolant heated by a reactor core, and generate electricity by rotating a turbine by the steam. During reactor cooling and in case of an accident, the steam generator removes residual heat of a primary system.

A steam generator of a commercial nuclear plant may be a separate type connected to a reactor vessel through piping, that is, a recirculating U-tube steam generator in which high-temperature reactor coolant of the primary system flows within a tube.

Differently from in the commercial nuclear plant, a steam generator of a system-integrated modular advanced reactor (SMART) may be a once-through helical steam generator built in a reactor vessel. In addition, the steam generator circulates secondary side cooling water through the tube and directly produces superheated steam through heat exchange between the circulated secondary side cooling water and primary side reactor coolant flowing outside of the tube. During reactor cooling and in case of an accident, the steam generator removes residual heat of a primary system.

The tubes of the once-through helical steam generator used in the SMART are helically arranged, forming concentric circles surrounding an inner pipe, and wound in a plurality of rows. Tubes in neighboring rows are wound in opposite directions from each other to be alternate and are connected to a feed water and steam header of the steam generator.

### SUMMARY

An aspect of the present invention provides a feed water and steam header of a steam generator in a nuclear reactor in which the steam generator is installed in a reactor vessel.

According to an aspect of the present invention, there is provided a feed water and steam header of a steam generator in an integrated nuclear reactor, the feed water and steam header including a nozzle connection portion connected to a steam nozzle or a feed water nozzle of a reactor vessel, a header flange protruded outward from a lower part of the nozzle connection portion, and a tube connection portion disposed on two pipelines branched from the nozzle connection portion and connected to a tube of the steam generator.

The tube connection portion may be branched in two directions with respect to the nozzle connection portion at a predetermined angle.

The tube connection portion may be branched at 90°.

The tube connection portion may include a tube sheet to which a plurality of tubes are connected.

A fastening portion may be formed at an end of the nozzle connection portion to be fastened to the steam nozzle or the feed water nozzle.

According to another aspect of the present invention, there is provided a nuclear reactor including a reactor vessel, a steam generator disposed in the reactor vessel and wound with a plurality of tubes in a coil form, a feed water nozzle disposed at a lower part of the reactor vessel to introduce cooling water into the steam generator, a steam nozzle disposed at an upper part of the reactor vessel to exhaust steam generated from the steam generator, and a feed water and steam header disposed in the reactor vessel to interconnect the feed water nozzle, the steam nozzle, and the steam generator.

The feed water and steam header may include a nozzle connection portion insertedly connected to the steam nozzle or the feed water nozzle, a header flange protruded outward from a lower part of the nozzle connection portion, and a tube connection portion disposed on two pipelines branched from the nozzle connection portion and connected to the plurality of tubes of the steam generator.

The tube connection portion may be branched in two directions with respect to the nozzle connection portion at a predetermined angle.

The tube connection portion may be branched at 90°.

The tube connection portion may include a tube sheet to which a plurality of tubes are connected.

A fastening portion may be formed at an end of the nozzle connection portion to be fastened to the steam nozzle or the feed water nozzle.

### EFFECT

According to embodiments of the present invention, a feed water and steam header of a steam generator for an integrated nuclear reactor may be configured to occupy a relatively small installation space, complying with the characteristics of the integrated nuclear reactor.

Additionally, according to embodiments of the present invention, a feed water nozzle and a steam nozzle for a reactor vessel and a feed water and steam header for a steam generator are efficient in terms of coupling and sealing and convenient in installation and disassembling.

Additionally, according to embodiments of the present invention, a feed water and steam header is conveniently connected with helically alternating tubes. Furthermore, the feed water and steam header is accessible to the tubes so that in-service inspection (ISI) with respect to the tubes is available.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a perspective view of a feed water and steam header according to an embodiment of the present invention;

FIG. 2 are sectional views and plan views of the feed water and steam header of FIG. 1;

FIG. 3 is a sectional view illustrating main elements in a state in which the feed water and steam header of FIG. 1 is connected to a steam nozzle; and

FIG. 4 is a sectional view illustrating main elements in a state in which the feed water and steam header of FIG. 1 is connected to a feed water nozzle.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. In describing the embodiments, generally known functions and structures will not be explained in detail for conciseness.

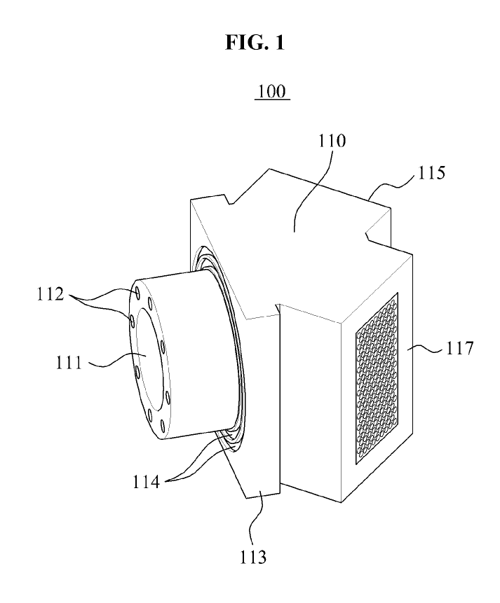

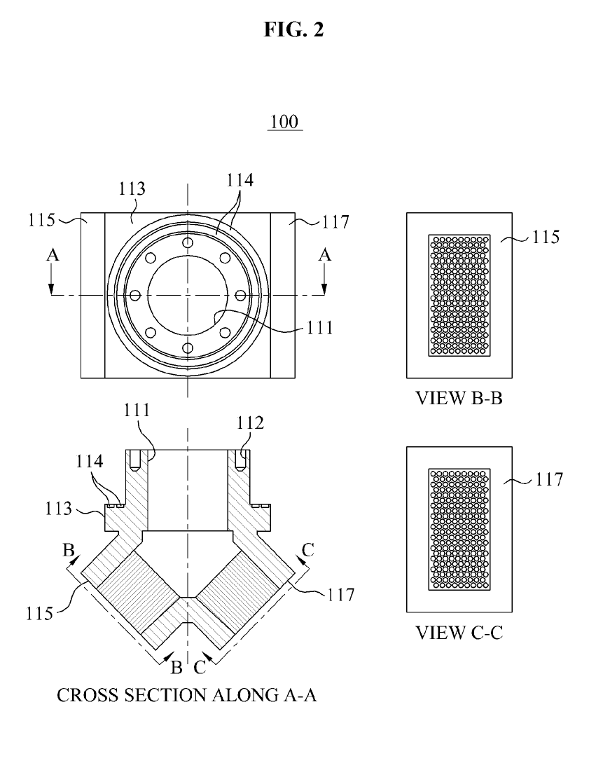

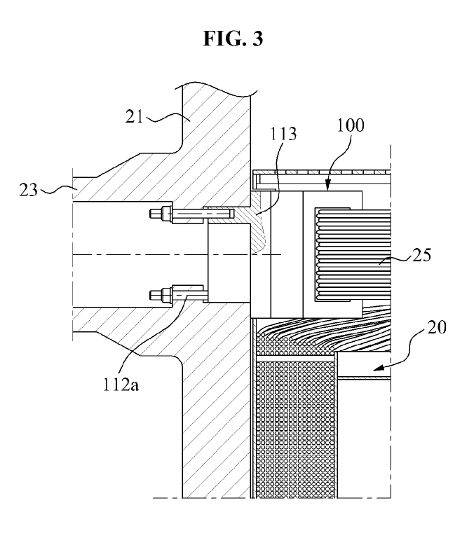

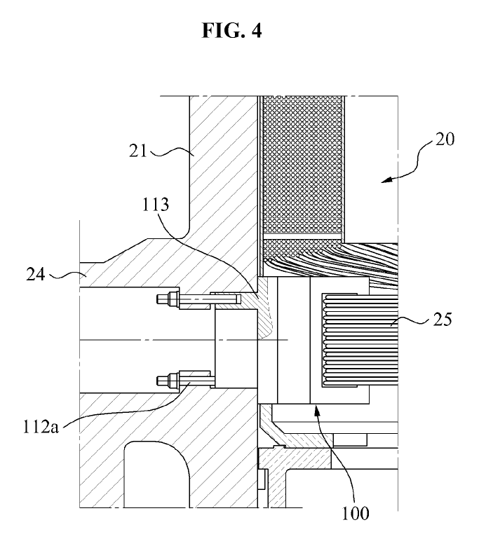

Hereinafter, a feed water and steam header 100 for a steam generator according to an embodiment of the present invention will be described in detail with reference to FIGS. 1 to 4. FIG. 1 is a perspective view of the feed water and steam header 100. FIG. 2 are sectional views and plan views of the feed water and steam header 100. FIG. 3 is a sectional view in which the feed water and steam header 100 is connected to a steam nozzle 23 of a steam generator 20. FIG. 4 is a sectional view illustrating main elements in a state in which the feed water and steam header 100 is connected to a feed water nozzle 24.

Referring to the drawings, the steam generator 20 may include a bundle of heat transfer tubes 25 wound into a helical coil. Hereinafter, the heat transfer tube will be briefly referred to as a ‘tube.’ A reactor coolant heated by a reactor core may flow outside the tubes 25. Secondary cooling water may flow in the tubes 25. The secondary cooling water is heated by heat of the reactor coolant at a high temperature and high pressure, thereby generating steam. For example, the tubes 25 are wound along an inner cylinder of the steam generator 20 to be slant at a predetermined angle. Odd-number rows of the tubes 25 may be wound clockwise while even-number rows are wound counterclockwise, so that the odd-number rows and the even-number rows are alternated.

Since structures of a steam generator of an integrated nuclear reactor, that is, the steam generator 20, are generally known in the art and not essential features of the present invention, only main elements will be briefly explained while omitting specific description about the structures.

The feed water nozzle 24 for feeding water to the tubes 25 may be connected to a feed water header disposed at a lower part of the steam generator 20. The steam nozzle 23 for exhausting steam generated by the tubes 25 may be connected to a steam header disposed at an upper part of the steam generator 20.

The feed water and steam header 100 may be fixed to an inside of a reactor vessel 21 to be connected to the steam nozzle 23 and the feed water nozzle 24 of the reactor vessel 21. The feed water and steam header 100 may be disposed inside an upper structure of the steam generator 20 to collect and guide superheated steam generated in the tubes 25 toward the steam nozzle 23. In addition, the feed water and steam header 100 may be disposed inside a lower structure of the steam generator 20 to distribute the secondary cooling water supplied through the feed water nozzle 24 to the tubes 25.

The feed water and steam headers 100 having the same structure may be connected to the steam nozzle 23 and the feed water nozzle 24, respectively.

In detail, the feed water and steam header 100 may include a Y-shape housing 110 including tube connection portions 115 and 117 respectively provided on two pipelines branched from a nozzle connection portion 111. The feed water and steam header 100 may be disposed in the reactor vessel 21. The steam generator 20 may be fixed to the reactor vessel 21 using a fastening member 112a such as a stud bolt. A reference numeral 112 in the drawings denotes a fastening portion 112 for fixing the feed water and steam header 100 to the feed water nozzle 24 or the steam nozzle 23 disposed in the reactor vessel 21.

The nozzle connection portion 111 may be in a cylindrical shape to be inserted in the steam nozzle 23 and the feed water nozzle 24. The nozzle connection portion 111 inserted in the steam nozzle 23 and the feed water nozzle 24 may provide a path for the secondary cooling water introduced through the nozzle connection portion 111 to smoothly flow into the tubes 25.

In addition, the feed water nozzle 24 and the steam nozzle 23 may be fastened to an end of the nozzle connection portion 111 using the fastening member 112a.

A header flange 113 may be protruded outward at an end of the nozzle connection portion 111 opposite to the end connected with the feed water nozzle 24 and the steam nozzle 23. The header flange 113 may be protruded in outer directions more than the nozzle connection portion 111 and formed in a circular shape along a circumference of the nozzle connection portion 111. As shown in FIG. 3 or 4, the header flange 113 may be connected to an inner surface of the reactor vessel 21. Here, the header flange 113 may include a sealing member (not shown) for sealing of the feed water nozzle 24 and the steam nozzle 23 with respect to the feed water and steam header 100. For example, the header flange 113 may include an O-ring groove 114 equipped with an O-ring for sealing. In addition, the header flange 113 may include two concentric O-ring grooves 114 arranged at a predetermined distance so that two O-rings may be provided.

The tube connection portions 115 and 117 may include two tube sheets to provide fixing ends for fixing the tubes 25 helically arranged. Feed water and steam are fed through a space formed by the tube sheets. The tubes 25 may be disposed such that in-service inspection (ISI) of the tubes 25 may be performed through an inside of the feed water and steam header 100.

The tube connection portions 115 and 117 may be disposed to form a predetermined angle, for example about 90°, with respect to the nozzle connection portion 111, for connection of the helically alternating tubes 25. Since the tube connection portions 115 and 117 are thus broadened at the predetermined angle, connection of the tubes 25 to the tube sheets may be facilitated.

According to the foregoing embodiment, the feed water and steam header 100 may include a Y-shape path disposed in the housing 110 and extended from the nozzle connection portion 111 to the tube connection portions 115 and 117. Therefore, the secondary cooling water introduced through the nozzle connection portion 111 may be efficiently fed to the tubes 25. Also, steam generated in the tubes 25 may be efficiently exhausted to the steam nozzle 23 through the nozzle connection portion 111. In addition, the feed water and steam header 100 according to the present embodiment may maximize heat transfer efficiency by minimizing path blocking by primary side coolant. In addition, since the tubes 25 are connected to the tube sheets separated by about 90°, the entire size and volume of the steam generator 20 may be reduced when compared to a case of using a single tube sheet. As a result, a smaller feed water and steam header 100 appropriate for the steam generator 20 for the integrated nuclear reactor may be provided.

Furthermore, the same type of the feed water and steam header 100 may be applied to the steam nozzle 23 and the feed water nozzle 24. In addition, since the feed water and steam header 100 and the reactor vessel 21 are fixed using the fastening member 112a such as the stud bolt, that is, since the feed water and steam header 100 may be fixed in a simple manner, the embodiments may be applied to various types of reactors.

In addition, the ISI of the tubes 25 may be easily performed using the feed water and steam header 100.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A feed water and steam header of a steam generator in an integrated nuclear reactor, the feed water and steam header comprising:
a nozzle connection portion connected to a steam nozzle or a feed water nozzle of a reactor vessel;
a header flange protruded outward from a lower part of the nozzle connection portion; and
a tube connection portion disposed on two pipelines branched from the nozzle connection portion and connected to a tube of the steam generator.

2. The feed water and steam header of claim 1, wherein the tube connection portion is branched in two directions with respect to the nozzle connection portion at a predetermined angle.

3. The feed water and steam header of claim 2, wherein the tube connection portion is branched at 90°.

4. The feed water and steam header of claim 1, wherein the tube connection portion comprises a tube sheet to which a plurality of tubes are connected.

5. The feed water and steam header of claim 1, wherein a fastening portion is formed at an end of the nozzle connection portion to be fastened to the steam nozzle or the feed water nozzle.

6. An integrated reactor comprising:
a reactor vessel;
a steam generator disposed in the reactor vessel and wound with a plurality of tubes in a coil form;
a feed water nozzle disposed at a lower part of the reactor vessel to introduce cooling water into the steam generator;
a steam nozzle disposed at an upper part of the reactor vessel to exhaust steam generated from the steam generator; and
a feed water and steam header disposed in the reactor vessel to interconnect the feed water nozzle, the steam nozzle, and the steam generator.

7. The integrated reactor of claim 6, wherein the feed water and steam header comprises:
a nozzle connection portion insertedly connected to the steam nozzle or the feed water nozzle;
a header flange protruded outward from a lower part of the nozzle connection portion; and
a tube connection portion disposed on two pipelines branched from the nozzle connection portion and connected to the plurality of tubes of the steam generator.

8. The integrated reactor of claim 7, wherein the tube connection portion is branched in two directions with respect to the nozzle connection portion at a predetermined angle.

9. The integrated reactor of claim 8, wherein the tube connection portion is branched at 90°.

10. The integrated reactor of claim 7, wherein the tube connection portion comprises a tube sheet to which a plurality of tubes are connected.

11. The integrated reactor of claim 7, wherein a fastening portion is formed at an end of the nozzle connection portion to be fastened to the steam nozzle or the feed water nozzle.
